(19) United States
(12) Patent Application Publication
(10) Pub. No.: US 2026/0239176 A1
(43) Pub. Date: Aug. 13, 2026

(54) TAC HANDLING FOR MOBILE IAB

(71) Applicant: Samsung Electronics Co., Ltd., Suwon-si, Gyeonggi-do (KR)

(72) Inventors: Jonas SEDIN, Staines (GB); Milos TESANOVIC, Staines (GB)

(21) Appl. No.: 19/156,305

(22) PCT Filed: Feb. 14, 2024
(86) PCT No.: PCT/KR2024/002087

§ 371 Date: Aug. 13, 2025

(30) Foreign Application Priority Data
Feb. 16, 2023 (GB) 2302229.6

(51) Int. Cl. H04W 48/10; H04W 64/00; H04W 84/00

(52) U.S. Cl. CPC H04W 48/10; H04W 64/006; H04W 84/005

(57) ABSTRACT

The disclosure relates to a 5G or 6G communication system for supporting a higher data transmission rate. A method of a mobile integrated access and backhaul (IAB) node in a wireless communication network, the method comprising: obtaining system information including a first field in which a first tracking area code (TAC) is set and a second field in which a second TAC is set; and broadcasting the system information, wherein the first TAC is for a first group of user equipments (UEs) connected to the mobile IAB node, and the second TAC is for a second group of UEs connected to the mobile IAB node.

### TECHNICAL FIELD

Certain examples of the present disclosure provide one or more techniques for a mobile access node. For example, certain examples of the present disclosure provide one or more techniques for a mobile Integrated Access and Backhaul (IAB) node, in a 3rd Generation Partnership Project (3GPP) 5th Generation (5G) New Radio (NR) network.

### BACKGROUND ART

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The content of the following documents is referred to below and/or their content provides background information and context that the following disclosure should be considered in view of:
[1] 3GPP TS 22.261;
3rd Generation Partnership Project; Technical Specification Group Services and System Aspects; Service requirements for the 5G system; SA1;
Release 18 (e.g., V18.8.0)/Release 19 (e.g., V19.1.0);
[2] RP-213599, 3GPP TSG RAN Meeting #94e;
Study on Artificial Intelligence (AI)/Machine Learning (ML) for NR Air Interface.
[3] 3GPP TS 38.413;
3rd Generation Partnership Project; Technical Specification Group Radio Access Network; NG-RAN; NG Application Protocol (NGAP);
Release 17 (e.g., V17.0.0).
[4] 3GPP TS 38.423;
3rd Generation Partnership Project; Technical Specification Group Radio Access Network; NG-RAN; Xn application protocol (XnAP);
Release 17 (e.g., V17.3.0).
[5] 3GPP TS 38.331;
3rd Generation Partnership Project; Technical Specification Group Radio Access Network; NR; Radio Resource Control (RRC) protocol specification
Release 17 (e.g., V17.3.0).
[6] Sharifi, Sepehr, et al. “Identifying the Hazard Boundary of ML-enabled Autonomous Systems Using Cooperative Co-Evolutionary Search.” arXiv preprint arXiv: 2301.13807 (2023).

(Note: the example versions shown for each TS are non-limiting, other versions of the TS may be considered also)

### DISCLOSURE OF INVENTION

### Technical Problem

The present disclosure relates to wireless communication systems and, more specifically, the invention relates to methods and apparatus for TAC handling for mobile IAB.

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims.

Embodiments or examples disclosed in the description and/or figures falling outside the scope of the claims are to be understood as examples useful for understanding the present invention.

Other aspects, advantages and salient features of the invention will become apparent to those skilled in the art from the following detailed description taken in conjunction with the accompanying drawings.

In one embodiment, A method of a mobile integrated access and backhaul (IAB) node in a wireless communication network, the method comprising: obtaining system information including a first field in which a first tracking area code (TAC) is set and a second field in which a second TAC is set; and broadcasting the system information, wherein the first TAC is for a first group of user equipments (UEs) connected to the mobile IAB node, and the second TAC is for a second group of UEs connected to the mobile IAB node.

In another embodiment, a mobile integrated access and backhaul (IAB) node in a wireless communication network, the mobile IAB node comprising: a transceiver; and a processor configured to: obtain system information including a first field in which a first tracking area code (TAC) is set and a second field in which a second TAC is set, and broadcast the system information, wherein the first TAC is for a first group of user equipments (UEs) connected to the mobile IAB node, and the second TAC is for a second group of UEs connected to the mobile IAB node.

### Advantageous Effects of Invention

Advantages, and salient features of the invention will become apparent to those skilled in the art from the following detailed description, which, taken in conjunction with the annexed drawings, discloses exemplary embodiments of the invention.

According to various embodiments of the present disclosure, method and apparatus for TAC handling for mobile IAB.

### BRIEF DESCRIPTION OF DRAWINGS

FIG. 1 (from 3GPP TR 38.874 V16.0.0) illustrates a two-hop IAB network;

FIG. 2 is FIG. 5.2.2-1 from 3GPP TS 38.304, V17.2.0;

FIG. 3 is FIG. 5.3.1-1 from 3GPP TR 23.700-05 V18.0.0;

FIG. 4 illustrates a scenario resulting in a so-called TAU storm due to updated TAs;

FIG. 5a illustrates example of the present disclosure for signalling tracking areas by a mobile IAB;

FIG. 5b illustrates example of the present disclosure for signalling tracking areas by a mobile IAB;

FIG. 6 illustrates a third example of the present disclosure for signalling tracking areas by a mobile IAB;

FIG. 7a is flow diagram of example of the present disclosure for handling signalled tracking areas by a UE;

FIG. 7b is flow diagram of example of the present disclosure for handling signalled tracking areas by a UE;

FIG. 8 is a flow diagram of an example of the present disclosure for selecting a signalled tracking area by a UE;

FIG. 9a is signal flow diagram of example of the present disclosure for setting up or updating a tracking area by a gNB;

FIG. 9b is signal flow diagram of example of the present disclosure for setting up or updating a tracking area by a gNB; and

FIG. 10 is a block diagram of an exemplary network entity that may be used in certain examples of the present disclosure.

### MODE FOR THE INVENTION

### Overview of Integrated Access and Backhaul (IAB)

In 3rd Generation Partnership Project (3GPP) 5th Generation (5G) New Radio (NR), Integrated Access and Backhaul (IAB) is a technique for providing wireless backhaul as an alternative to a fibre backhaul network. An IAB network comprises IAB nodes, at which wireless resources are shared between wireless backhaul and access links. By means of such a configuration, it is possible to install nodes without the necessity of providing a fibre data connection, thereby allowing speedy and simple roll out of network coverage to locations where no such data connection is available or possible. Due to the limited coverage area of an IAB node, the backhaul network is typically implemented as a multi-hop network with backhaul traffic traversing multiple IAB nodes.

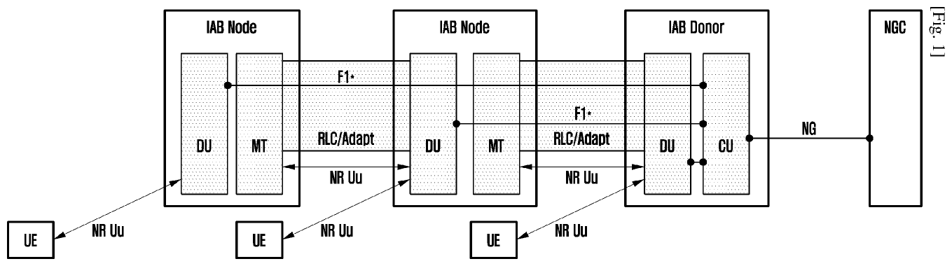

FIG. 1 shows a two-hop IAB network as described in 3GPP NR Rel-16 and further enhanced in Rel-17. 3GPP 5G Release 16 was the first release comprising the IAB feature. Release 17 comprised enhancements on top of the Release 16 baseline and is now frozen. Work on Release 18 is currently underway to develop and improve features relating to IAB relative to previous Releases, most notably the mobility of IAB nodes. Assumption in previous Releases was that IAB nodes are stationary.

### Overview of Mobile IAB

As noted in the original Release 18 IAB 3GPP Work Item Description (WID), “At the beginning of the work period, RAN3, RAN2 should discuss the potential complexity of a scenario where a mobile IAB node connects to a stationary (intermediate) IAB node, with respect to the scenario where a mobile IAB node connects directly to an IAB-donor.” This topic was discussed in RAN2 #119-e and the following was agreed:

R2 assumes that Mobile IAB connecting to a stationary (intermediate) IAB node is/can be supported. R2 assumes this can be supported with no (or limited) impact.

The assumption in Release 18 is therefore that a mobile IAB node connects to the gNB (Donor DU) either directly or via other IAB nodes which are stationary. There is therefore multi-hop support in Release 18 but the assumption is that intermediate nodes (if any) are stationary.

### Overview of Radio Resource Control (RRC) Idle/Inactive Idle Mode Procedures

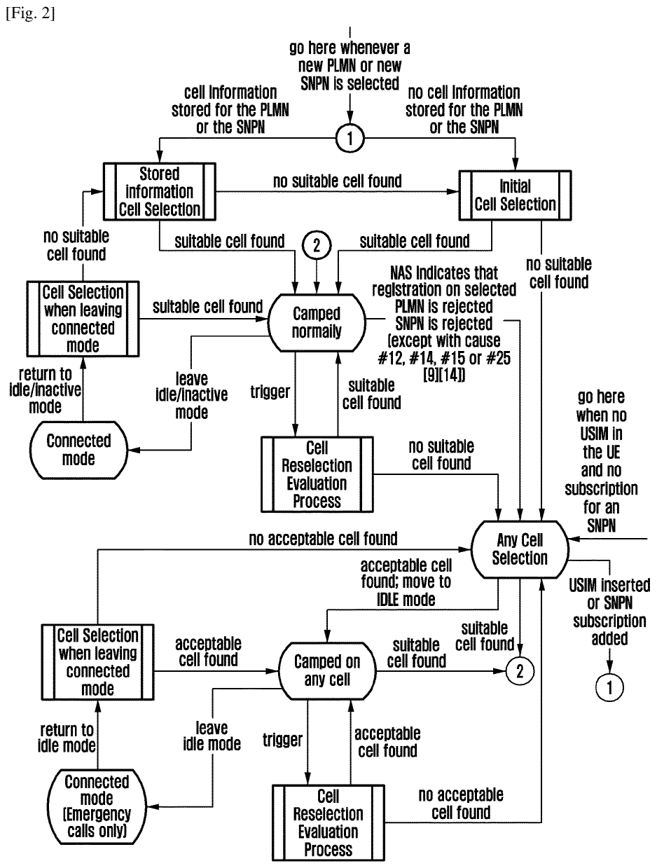

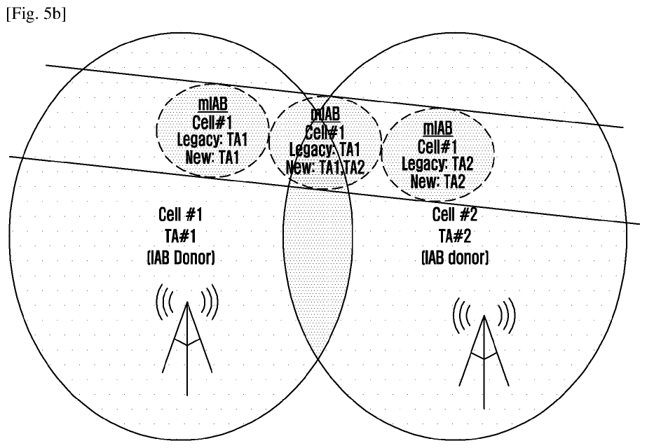

The procedures for a UE in RRC idle mode are illustrated in FIG. 2 (which is FIG. 5.2.2-1 from 3GPP TS 38.304, V17.2.0).

The idle mode procedures include:
Public Land Mobile Network (PLMN) selection
The UE scans and reports detected PLMNs to Non Access Stratum (NAS). A PLMN is reported as a high quality PLMN if the measured Reference Signal Received Power (RSRP) value is greater than-110 dBm.
Cell selection
UE selects an (possibly initial) cell based on two criteria known as the cell selection criteria. The UE selects a cell that fulfils the criteria, but if multiple cells satisfy the criteria, it is not specified which of those cells the UE shall select. The criteria are based on the received power level as well as the quality of the signal, which are in turn based on signalled thresholds and measurements.
Cell reselection
Cell reselection is performed for the UE to camp on the most suitable cell. In addition to the cell selection criteria, the UE also ranks different cells of the same priority to choose the best cell. The UE also measures on different frequencies that have either higher or lower priority, which ensures that the UE always camps on the best cell with the highest priority.
Location registration and Radio Access Network (RAN) Area Registration
Tracking Area registration—The UE reports the tracking area information to NAS. If a UE camps on a new tracking area, a Tracking Area Update (TAU) is triggered. This can also be done periodically.
RAN Area Registration—The UE performs a RAN-based notification area update when the UE camps on a new cell that does not belong to the current RAN Notification Area (RNA). This can also be done periodically.

### Overview of RANAC and TAC and Related Procedures

Tracking Areas are utilized by a (core) network to allow for a network to be able to reach a UE when it is idle mode. A UE can in general perform idle mode mobility without indicating to a new cell that it is camping on it. Whenever a UE has entered a new Tracking Area, it will be required to announce its presence using a so-called Tracking Area Update (sometimes also referred to as a mobility registration). This allows the (core) network to be aware within which cell is located in to remain reachable.

The Tracking Area Codes are signalled in a cell. What is signalled is the following:

### 3GPP TS 38.331 V17.3.0

### PLMN-IdentityInfoList

The IE PLMN-IdentityInfoList includes a list of PLMN identity information.

### PLMN-IdentityInfoList Information Element

-- ASN1START
-- TAG-PLMN-IDENTITYINFOLIST-START
PLMN-IdentityInfoList ::= SEQUENCE (SIZE (1..maxPLMN)) OF PLMN-IdentityInfo
PLMN-IdentityInfo ::= SEQUENCE {
plmn-Identity List SEQUENCE (SIZE (1..maxPLMN)) OF PLMN-Identity,
trackingAreaCode TrackingAreaCode OPTIONAL, -- Need R
ranac RAN-AreaCode OPTIONAL, -- Need R
cellIdentity CellIdentity,
cellReservedForOperatorUse ENUMERATED {reserved, notReserved},
...,
└└
iab-Support-r16 ENUMERATED {true} OPTIONAL -- Need S
┘┘,
└└
trackingAreaList-r17 SEQUENCE (SIZE (1..maxTAC-r17)) OF TrackingAreaCode OPTIONAL, -- Need R
gNB-ID-Length-r17 INTEGER (22..32) OPTIONAL -- Need R
┘┘
}
-- TAG-PLMN-IDENTITYINFOLIST-STOP
-- ASN1STOP

TABLE 1
PLMN-IdentityInfo field descriptions

cellReservedForOperatorUse
Indicates whether the cell is reserved for operator use (per PLMN), as
defined in TS 38.304 [20]. This field is ignored by IAB-MT.
gNB-ID-Length
Indicates the length of the gNB ID out of the 36-bit long cellIdentity.
iab-Support
This field combines both the support of IAB and the cell status for IAB.
If the field is present, the cell supports IAB and the cell is also considered
as a candidate for cell (re)selection for IAB-node; if the field is absent,
the cell does not support IAB and/or the cell is barred for IAB-node.
trackingAreaCode
Indicates Tracking Area Code to which the cell indicated by cellIdentity
field belongs. The absence of the field indicates that the cell only supports
PSCell/SCell functionality (per PLMN) or is an NTN cell.
trackingAreaList
List of Tracking Areas to which the cell indicated by cellIdentity field
belongs. If this field is present, network does not configure
trackingAreaCode. Total number of different TACs across different
PLMN-IdentityInfos shall not exceed maxTAC. This field is only
present in an NTN cell.

### GPP TS 38.331 V17.3.0

When the UE receives reads the SIB1 containing the Tracking Area, the UE will forward the Tracking Areas to upper layers (NAS), which then decides on the course of action according to the following (with emphasis added):

### 3GPP TS 38.331 V17.3.0

### 5.2.2.4.2 Actions Upon Reception of the SIB1

Upon receiving the SIB1 the UE shall:
1> store the acquired SIB1;
<OMITTED>
1> if the cellAccessRelatedInfo contains an entry of a selected SNPN or PLMN and in case of PLMN the UE is either allowed or instructed to access the PLMN via a cell for which at least one CAG ID is broadcast:
   2> in the remainder of the procedures use npn-IdentityList, trackingAreaCode, and cellIdentity for the cell as received in the corresponding entry of npnIdentityInfoList containing the selected PLMN or SNPN;
1> else if the cellAccessRelatedInfo contains an entry with the PLMN-Identity of the selected PLMN:
   2> in the remainder of the procedures use plmn-IdentityList, trackingAreaCode, trackingAreaList, and cellIdentity for the cell as received in the corresponding PLMNIdentityInfo containing the selected PLMN;
<OMITTED>
1> else:
<OMITTED>
   2> if frequencyShift7p5 khz is present and the UE supports corresponding 7.5 kHz frequency shift on this band; or frequencyShift7p5 khz is not present:
      3> if neither trackingAreaCode nor trackingAreaList is provided for the selected PLMN nor the registered PLMN nor PLMN of the equivalent PLMN list:
         4> consider the cell as barred in accordance with TS 38.304 [20];
         4> perform cell re-selection to other cells on the same frequency as the barred cell as specified in TS 38.304 [20];
      3> else if UE is IAB-MT and if iab-Support is not provided for the selected PLMN nor the registered PLMN nor PLMN of the equivalent PLMN list nor the selected SNPN nor the registered SNPN:
         4> consider the cell as barred for IAB-MT in accordance with TS 38.304 [20];
      3> else:
         4> apply a supported uplink channel bandwidth with a maximum transmission bandwidth which
         is contained within the carrierBandwidth indicated in uplinkConfigCommon for the SCS of the initial uplink BWP or, for RedCap UEs, RedCapspecific initial uplink BWP, if configured, and which
         is wider than or equal to the bandwidth of the initial BWP for the uplink or, for a RedCap UE, of the RedCap-specific initial uplink BWP if configured;
         4> apply a supported downlink channel bandwidth with a maximum transmission bandwidth which
         is contained within the carrierBandwidth indicated in downlinkConfigCommon for the SCS of the initial downlink BWP or, for RedCap UEs, RedCapspecific initial downlink BWP, if configured, and which
         is wider than or equal to the bandwidth of the initial BWP for the downlink or, for a RedCap UE, of the RedCap-specific initial downlink BWP if configured;
         4> select the first frequency band in the frequencyBandList, for FDD from frequencyBandList for uplink, or for TDD from frequencyBandList for downlink, which the UE supports and for which the UE supports at least one of the additionalSpectrumEmission values in nr-NS-PmaxList, if present;
         4> forward the cellIdentity to upper layers;
         4> forward the trackingAreaCode to upper layers;
         4> forward the trackingAreaList to upper layers, if included;
         4> forward the received posSIB-MappingInfo to upper layers, if included;
         4> forward the PLMN identity or SNPN identity or PNI-NPN identity to upper layers;
         4> if in RRC_INACTIVE and the forwarded information does not trigger message transmission by upper layers:
         5> if the serving cell does not belong to the configured ran-NotificationAreaInfo:
         6> initiate an RNA update as specified in 5.3.13.8;
         4> forward the ims-EmergencySupport to upper layers, if present;
         4> forward the eCallOverIMS-Support to upper layers, if present;
         4> forward the UAC-AccessCategory1-SelectionAssistanceInfo or UAC-AC1-SelectAssistInfo for the selected PLMN/SNPN to upper layers, if present and set to a, b or c;
         4> if the UE is in SNPN access mode:
         5> forward the imsEmergencySupportForSNPN indicators with the corresponding SNPN identities to upper layers, if present;
         4> apply the configuration included in the servingCellConfigCommon;
         4> apply the specified PCCH configuration defined in 9.1.1.3;

### 3GPP TS 38.331 V17.3.0

### Overview of RRC Idle and RRC Inactive Procedures

RRC inactive is a state in which the UE may move faster to connected mode compared to RRC idle, for example to perform data transmission. The transition to connected mode is faster because the gNB maintains the UE context when the UE is in inactive mode. This means that the UE does not need to re-initiate security and the UE does not need to be fully re-configured whenever the UE re-connects.

This mechanism is enabled by the UE being configured with a RAN Notification Area (RNA) where the UE may camp within without having to notify RAN. The UE may perform RRC Resume for Mobile Originated data as long as the RNA remains the same.

The above information is presented as background information only to assist with an understanding of the present disclosure. No determination has been made, and no assertion is made, as to whether any of the above might be applicable as prior art with regard to the present invention.

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the present disclosure provide one or more techniques for a mobile access node. For example, certain examples of the present disclosure provide one or more techniques for a mobile IAB node, in a 3GPP 5G NR network. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example, the functionality of a base station or the like (e.g. eNB, gNB, NB, RAN node, access point, wireless point, transmission/reception point, central unit, distributed unit, radio unit, remote radio head, etc.) in the examples herein may be applied to any other suitable type of entity performing RAN functions, the functionality of an IAB or the like in the examples herein may be applied to any other suitable type of entity performing a relay, and the functionality of a UE or the like (e.g. electronic device, user device, mobile station, subscriber station, customer premises equipment, terminal, remote terminal, wireless terminal, vehicle terminal, etc.) in the examples herein may be applied to any other suitable type of device.

The skilled person will appreciate that the various examples disclosed herein may be implemented using existing messages (e.g. RRC messages) or any other suitable messages. The skilled person will appreciate that the names of messages may vary across different RATs, for example NR and LTE (Evolved Universal Terrestrial Radio Access Network (E-UTRAN)). The skilled person will appreciate that examples disclosed herein referring to message names in one particular RAT (e.g. E-UTRAN) are not limited to that RAT, but may be applied to other RATs (e.g. NR).

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

At least the following problem exist in view of the related art.

In the Work Item Description [RP-220843, “Mobile IAB (Integrated Access and Backhaul) for NR”, RAN-P, Qualcomm, March 2022] the following problem statement is included:
Define Procedures for migration/topology adaptation to enable IAB-node mobility, including inter-donor migration of the entire mobile IAB-node (full migration) [RAN3, RAN2]
Enhancements for mobility of an IAB-node together with its served UEs, including aspects related to group mobility. No optimizations for the targeting of surrounding UEs. [RAN3, RAN2]

Furthermore, in the SA2 Technical Report 23.700-05 (V18.0.0), Study on architecture enhancements for vehicle-mounted relays, the following Key Issue is stated:

### 3GPP TR 23.700-05, V18.0.0

5.3 Key Issue #3: Efficient Mobility and Service Continuity when Served by Mobile Base Station Relay

### 5.3.1 General Description

When the moving vehicles are equipped with mobile base station relays (i.e. IAB-node), the mobile base station relays can provide 5G coverage and communication to UEs (inside the vehicle and/or in its vicinity), and connected wirelessly to the 5G network via IAB-donor gNB. When one or a group of UEs are already served by the mobile base station relay, there are two mobility scenarios to be studied as the following:
Scenario A (mobility within the same IAB-donor gNB): When the UEs are continuously served by a mobile base station relay (e.g. inside the vehicle and/or in its vicinity), this mobile base station relay within the vehicle is moving around within a limited geographical area while keeping connecting with the same IAB-donor gNB. In this case, the UE keeps the connection with the same mobile base station relay (i.e. IAB-node), and there is no change of the IAB-donor gNB as in FIG. 5.3.1-1.
Scenario B (mobility between different IAB-donor gNBs): When the UEs are continuously served by a mobile base station relay (e.g. inside the vehicle and/or in its vicinity), this mobile base station relay within the vehicle is moving around over a long distance. The mobile base station relay node connects with a different IAB-donor gNB if the vehicle keeps moving. In this case, the UE keeps the connection with the same mobile base station relay (i.e. IAB-node), but there is change of the IAB-donor gNB.

NOTE 1: For the above scenarios, whether the cell information in the System Information Broadcast (e.g. Cell ID, TAC) changes has RAN dependency.

NOTE 2: For the above scenarios, whether UE needs to perform the legacy handover procedures has RAN dependency.

### FIG. 5.3.1-1: Scenarios for Efficient Mobility and Service Continuity

The following aspects need to be studied for UEs served by the mobile base station relay in the case of mobility within the same IAB-donor gNB and mobility between different IAB-donor gNBs:
Whether and how to enhance current procedures of mobility and service continuity for a UE or a group of UEs, to efficiently deliver the data. Following aspects need to be considered in potential solutions:
   If the TAC in the System Information Broadcast changes, whether and how to enhance the NAS mobility procedure.
   If the handover is needed due to cell changes, whether and how to enhance the mobility for group UEs (e.g. during handover).

NOTE 3: Mechanisms related to mobility management and service continuity have RAN dependency and should align with the progress of RAN WGs.

### 3GPP TR 23.700-05, V18.0.0

In the conclusion the following is stated:

### 3GPP TR 23.700-05, V18.0.0

### 8.3 Conclusions for KI #3

For KI #3, the interim conclusions are as follows:
The UE's mobility management is performed using the legacy mechanism as defined in the TS 23.501 [2] and TS 23.502 [5]. The UE in CM-Idle shall follow legacy procedure when detecting a TAC which is not in the TA list.
The TAC broadcasted by the MBSR cell(s) is configured by the Donor gNB and whether this is the same as the one of the cell of the Donor gNB serving the MBSR, or not, will be based on alignment with RAN WGs and SA2 may align specifications if SA WG2 specifications impact is identified.

NOTE: Normative work will be based on RAN decisions.
Each UE connected via the MBSR may have different serving AMFs e.g., due to slicing and individual PDU sessions/QoS service flows configured. UE context handling and path switching would be handled per each individual UE.
No normative work for Group mobility of the UEs served by the MBSR. Alignment of specifications may be done only if RAN WGs decide to support this.

### 3GPP TR 23.700-05, V18.0.0

In RAN3 #118 the following was agreed:
Static TAC solution is not pursued.
RAN3 assumes that dynamic TAC solution should be supported.
RAN3 to continue discussions on impacts (if any) of dynamic TAC solutions on RAN3 specs

The notion of a dynamic TAC as opposed to a static TAC is that the Tracking Area can be changed for a cell and by extension the mobile IAB. The purpose of this is to ensure that the Tracking Area remains geographically fixed (i.e. fixed with respect to the ground) while the mobile IAB moves around. This is opposed to static TAC, where the TAC would remain with the mobile IAB as it moves around.

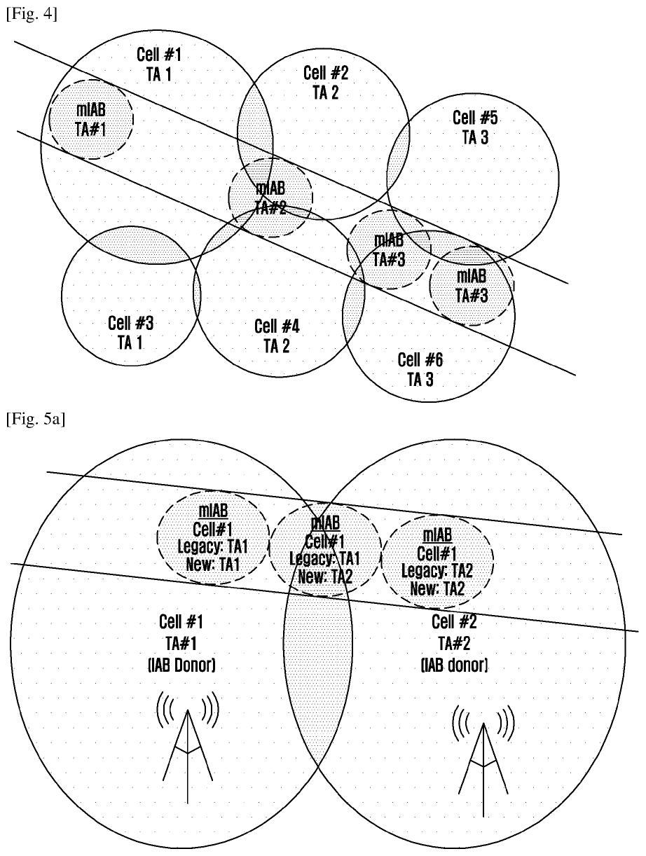

One problem with having a dynamic TAC is that when the Tracking Area changes, the UEs all have to perform Tracking Area Updates at the same time when the cell changes its Tracking Area. This might be challenging for a network to handle, causing core network congestion and potentially loss of service. An example of this problem can be seen in FIG. 4.

Another issue is that in the 3GPP work, the following is one of the guiding principles [RP-220843, Mobile IAB Integrated Access and Backhaul for NR, Qualcomm, RAN #95-e, March 2022]:

The Following Principles should be Respected: Mobile IAB-Nodes should be Able to Serve Legacy UEs.

This means that the network will still have to support UEs that are not enhanced, thus any enhancements introduced should not “break” the supported of non-enhanced UEs.

Certain examples of the present disclosure provide one or more techniques for alleviating Tracking Area Update storms by signalling multiple Tracking Area Fields that may be utilized by different UEs.

Various techniques disclosed herein may be applied, for example, to IAB-MTs & UEs, and gNBs, such as NG-RAN gNBs (for example in split CU/DU configuration), to which they connect. Various techniques disclosed herein may also be applied to IAB-MTs in EN-DC. Various techniques disclosed herein may be configured via RRC, for example through System Information via SIBs such as SIB1, SIB2, SIB3, etc.

In a typical scenario, there may exist a number of fixed cells, for example corresponding to donor gNBs. Each fixed cell may correspond to a fixed geographical area, and each may have a corresponding tracking area code (TAC) assigned to it. A mobile IAB (mIAB) node may move through the fixed cells. One or more UEs may be continuously attached to the mIAB as it moves through the fixed cells.

In this case, as the mIAB node moves through the fixed cells, the mIAB may broadcast the TAC of the fixed cell in which the mIAB is currently located. As the mIAB moves from a first fixed cell (e.g. cell #1 with TAC=TA1) to a second fixed cell (e.g. cell #2 with TAC=TA2), the TAC broadcast by the mIAB may change from TA1 to TA2 at the boundary between cell #1 and cell #2. At this time, each UE attached to the mIAB may have to perform a Tracking Area Update procedure. If many UEs are (continuously) attached to the mIAB then many TAUs occur at the same time, possibly causing network congestion.

On the other hand, in the scenario described above, in certain examples of the present disclosure, as the mIAB node moves through the fixed cells, the mIAB may broadcast two (or more) separate TACs, for example in two (or more) fields. The first TAC field may be used by legacy UEs while the other TAC field may be used by enhanced UEs.

FIG. 5a illustrates an example in which, when the mIAB moves from a first fixed cell (e.g. cell #1 with TAC=TA1) to a second fixed cell (e.g. cell #2 with TAC=TA2), the two TACs broadcast by the mIAB both change from TA1 to TA2 at the boundary between cell #1 and cell #2. However, the TAC broadcast in the first field changes before (or after) the TAC broadcast in the second field. This means that the TAUs of the legacy UEs are performed before the TAUs of the enhanced UEs. This in turn distributes the TAUs over a time window reducing the risk of network congestion.

FIG. 5b illustrates an example similar to FIG. 5a in which the second field may signal more than one TAC, and in which TACs signalled in the same field may change at different times.

The skilled person will appreciate that the mobile IAB does not necessarily need to broadcast the same TAC of its parent Donor gNB when TA1 and TA2 is different.

FIG. 6 illustrates an example in which, when the mIAB moves through a number of fixed cells with two different TACs, these two TACs are broadcast by the mIAB in the first and second fields. For example, in the scenario of FIG. 6, the mIAB moves through cells with TACs that constantly alternate between TA #1 and TA #2. The broadcast TACs may be “semi-static” in the sense that they are at least temporarily static (e.g. temporarily do not change). For example, in the case of FIG. 6, while the mIAB traverses the path indicated, TA #1 is always broadcast in the first field and TA #2 is always broadcast in the second field so that there are no TAUs along the entire mIAB path. Accordingly, in this example, the TA #1 and TA #2 as broadcasted by the mobile IAB cell may remain the same (static) at least for a while. Without this technique, the TAC would change a lot in the scenario of FIG. 6.

In certain examples, the first TAC field may change along with the fixed cells, whereas the second TAC field (TAC2) may remain static in this limited space (semi-static).

In certain examples, the TAC broadcast in one of the fields (e.g. the second field) may be a static TAC assigned to the mIAB which remains fixed when the mIAB moves through fixed cells (possibly having different TACs). This static TAC may be clearly separated/different from the TACs of the nearby fixed cells. The TAC broadcast in the other field (e.g. the first field) may be configured to change in a manner as described herein.

Certain examples of the present disclosure provide a method, for a mobile access node (e.g. a mobile IAB node) in a network, the method comprising: broadcasting system information, wherein the system information comprises two or more Tracking Area Codes (TACs).

In certain examples, the two or more TACs may comprise at least a first TAC signalled in a first field, and at least a second TAC signalled in a second field.

In certain examples, a first subset of the TACs (e.g. a TAC signalled in the first field) may be utilised by a first group of UEs connected to the mobile IAB node, and a second subset of the TACs (e.g. a TAC signalled in the second field) may be utilised by a second group of UEs connected to the mobile IAB node.

In certain examples, one of the first and second groups of UEs may be legacy UEs (e.g. UEs having a first level of capability), and the other of the first and second groups of UEs may be modified or enhanced UEs (e.g. UEs having a second level of capability different from or higher than the first level).

In certain examples, when the mobile IAB node is located in an area corresponding to (e.g. overlapping with) a first fixed cell, at least some of the TACs in the system information may be set to be the same as a TAC associated with the first fixed cell, or a TAC associated with a fixed cell adjacent/near to the first fixed cell.

In certain examples, when the mobile IAB node moves from an area corresponding to (e.g. overlapping with) a first fixed cell to an area corresponding to (e.g. overlapping with) a second fixed cell, at least some of the TACs in the system information may change from a first TAC to a second TAC.

In certain examples, the first TAC may be a TAC associated with the first fixed cell or a TAC associated with a fixed cell adjacent/near to the first fixed cell, and the second TAC may be a TAC associated with the second fixed cell or a TAC associated with a fixed cell adjacent/near to the second fixed cell.

In certain examples, at least some of the TACs broadcast in the system information may change at different times.

In certain examples, a TAC signalled in a first field of the system information may change at a different time to a TAC signalled in a second field of the system information.

In certain examples, a TAC signalled in a second field of the system information may change at a different time to another TAC signalled in the second field of the system information.

In certain examples, the system information may include two or more semi-static TACs (e.g. included in at least one of the first and second fields) respectively set to be the same as two or more TACs respectively associated with two or more sets of fixed cells, each set of fixed cells being associated with the same TAC, and the semi-static TACs may remain fixed while the mobile IAB moves within areas corresponding to (e.g. overlapping with) the two or more sets of fixed cells.

In certain examples, the method may further comprise: predicting a path of the mobile IAB node; determining, based on the predicted path, two or more sets of fixed cells along the predicted path, each set of fixed cells being associated with the same TAC; identifying two or more TACs associated with the determined cells; and setting the semi-static TACs as the identified TACs.

In certain examples, the system information may include at least one static TAC (e.g. included in at least one of the first and second fields) associated with the mobile IAB node that remains fixed.

In certain examples, the system information may be included in a system information block (e.g. SIB1).

Certain examples of the present disclosure provide a mobile access node (e.g. a mobile IAB node) configured to perform a method according to any example, aspect, embodiment and/or claim disclosed herein.

Certain examples of the present disclosure provide a network (or wireless communication system) comprising a mobile access node (e.g. a mobile IAB node) and one or more UEs according to any example, aspect, embodiment and/or claim disclosed herein.

Certain examples of the present disclosure provide a computer program comprising instructions which, when the program is executed by a computer or processor, cause the computer or processor to carry out a method according to any example, aspect, embodiment and/or claim disclosed herein.

Certain examples of the present disclosure provide a computer or processor-readable data carrier having stored thereon a computer program according to any example, aspect, embodiment and/or claim disclosed herein.

The skilled person will appreciate that, in various examples, the two or more TACs may be broadcast simultaneously, or substantially simultaneously (e.g. sequentially but in relatively quick succession, for example with a small time delay less than a certain threshold).

Various examples and aspect will now be described in more detail.

### Network Signalling (to UE)

In certain examples, a mobile IAB may signal two different Tracking Area fields, for example one using legacy tracking area for legacy UEs (first tracking area field) and one using a new field (second tracking area field) that could potentially be utilized by an enhanced UE.

These Tracking Areas may change at different times as the mIAB node moves, which means that different UEs camping on the same cell may camp on different Tracking Areas depending on capability. This can smooth out the transition of moving in between two different Tracking areas. An example of this is illustrated in FIG. 5a. In certain examples, the mobile IAB may signal tracking areas that are adjacent to current tracking areas.

In certain examples, multiple tracking areas may be included in the new field (second tracking area field, as illustrated in FIG. 5b). This may also be used to smooth out the transition of moving in between two different tracking areas.

FIG. 6 illustrates a scenario in which a UE attaching to an mIAB node moves (together with the mIAB node) for a long time in between multiple cells belonging to two different tracking areas. In this case, the tracking areas signalled in the first and second tracking area fields are semi-static in that they remain fixed for a certain time (e.g. during traversal of the path illustrated in FIG. 6). Without this technique, there would be constant tracking area updates in the scenario of FIG. 6.

In certain examples, the network may broadcast, in one of the tracking area fields (e.g. the second tracking area field), a static tracking area that is associated with the mIAB cell. This static tracking area is not changed when the mIAB cell moves around. For example, this technique may be applicable to future mobile networks.

The above information may be broadcast in any suitable way, for example in System-InformationBlocks, such as SIB1. In certain examples, the signalled information may be signalled in a mobile IAB-specific System Information Block.

### UE Actions

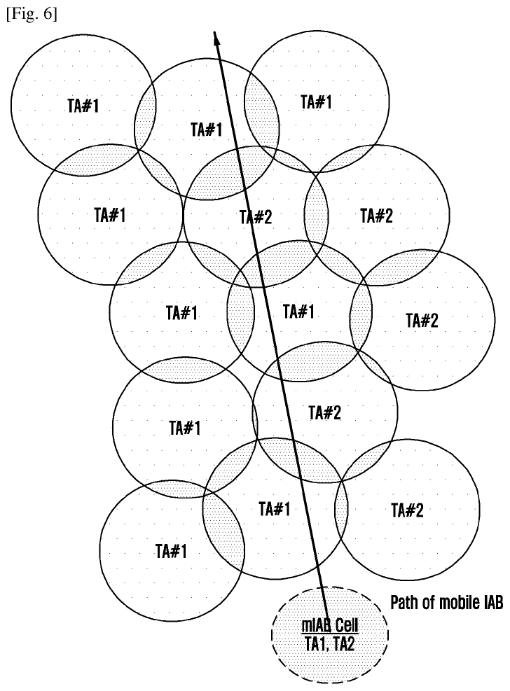

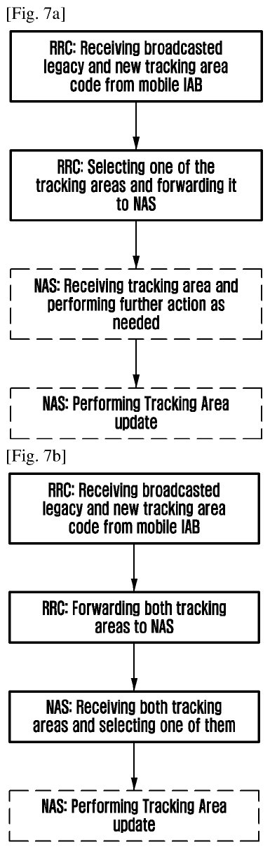

A UE may handle the multiple broadcast tracking areas in any suitable way. In certain examples, all of the information may be relayed to NAS, where the NAS makes the decision whether to camp on one Tracking Area as opposed to another. Alternatively, the decision may be made at RRC level, in which case only one of the tracking areas is sent to the NAS. Examples of these two scenarios are illustrated in FIGS. 7a and 7b.

In FIG. 7a, RRC receives broadcast first (e.g. legacy) and second (e.g. new) TACs from a mIAB. Next, RRC selects one of the TAs and forwards the corresponding TAC to NAS. Next, NAS receives the selected TAC and performs further action(s) as appropriate. For example, next, NAS performs a TAU.

In FIG. 7b, RRC receives broadcast first (e.g. legacy) and second (e.g. new) TACs from a mIAB. Next, RRC forwards both TACs to NAS. Next, NAS receives both TACs and selects one of them. Next, NAS performs further action(s) as appropriate. For example, NAS may perform a TAU.

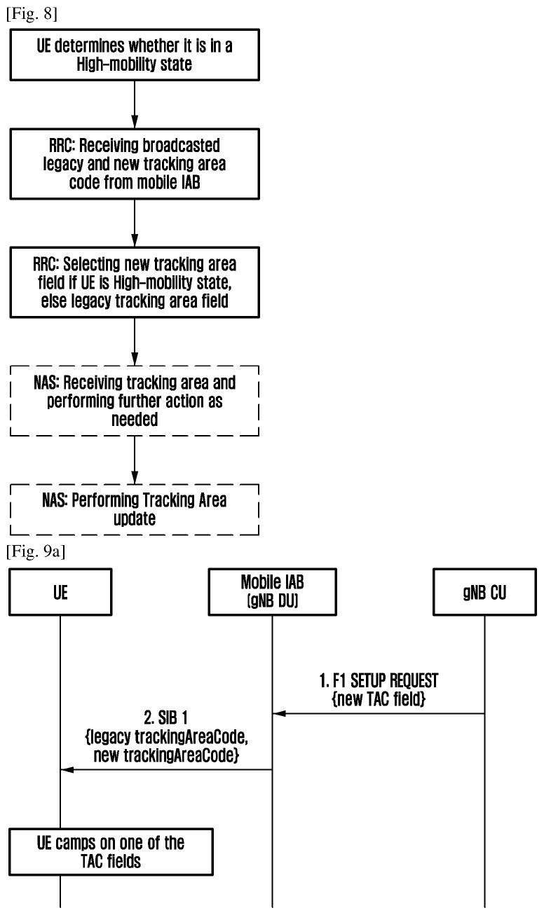

As described above, in certain examples, the RRC layer may forward one of the signalled tracking areas to NAS, which then makes the appropriate decision. This may be done in a number of ways, including one or more of the following:
The enhanced mobile IAB capable UE only forwards the new field to NAS, if the new field is present.
The enhanced mobile IAB capable UE selects one of the new and legacy fields to forward to NAS. This may be done in a number of ways, including one or more of the following:
   UE selects one field at random.
   UE is aware of it being on a moving platform (or not) and selects one of the fields, otherwise the legacy field is forwarded to NAS. This may ensure on-board UEs do not perform cell reselection to stationary cells. Determining being on a moving platform may for instance be done by utilizing Mobility States of a UE whether the UE is in a High-Mobility State, which may be decided via idle mode specification. An example of this is illustrated in FIG. 8 and in specification example 4 further below. Mobility States are used in idle mode to scale cell reselection rules based on whether the UE is High/Medium/Normal mobile. The state is determined according to rules on how many cell reselections are performed over a time-period. Movement may also be determined via additional signalling from the network indicating access point (mIAB node) speed and/or direction of movement, which the UE could compare to its own to infer its status.

As described above, in certain examples, the RRC layer may forward all of the signalled fields (e.g. legacy and new fields) and the NAS may take the appropriate decisions. This may be done in a number of ways, including one or more of the following:
The NAS only uses the new field if present.
NAS selects any of the new or legacy field. This may be done in a number of ways, including one or more of the following.
   Select a field at random.
   NAS is aware of the UE being a mobile UE and can thus select the appropriate TAC.
   NAS uses previous TAC history.

### Network Signalling (e.g. to AMF)

In certain examples, when communicating the user location (User Location Information), for example to the AMF, a mobile IAB gNB may signal one or more of the following:
Which specific Tracking Area the UE is located in, depending on whether the UE is an enhanced mobile IAB.
   If UE is an enhanced mobile IAB UE, the network sends the second Tracking Area Code field.
   If UE is not an enhanced mobile IAB UE, the network sends the first Tracking Area Code field.
Both tracking areas (e.g. the legacy and the new tracking areas) if the UE is an enhanced mobile IAB UE.

### Inter-Node Signalling to Support TAC Handling

To enable a gNB CU to setup its mobile cell or a mobile gNB DU according to the techniques disclosed herein, certain examples use signalling indicating which TACs to signal in the different fields. In certain example, the gNB CU may, in addition to indicating legacy TAC field for a mobile cell (a first TAC field), also indicate which new TAC field to use (a second TAC field) in the same mobile cell. This can for instance be signalled in the F1AP message F1 SETUP REQUEST or in the field Served Cell Information. An example of this is illustrated in FIG. 8.

In certain examples where the above information needs to be updated quickly, a new message specifically for the update may be introduced.

### FURTHER EXAMPLES

In certain examples, a timer or a timestamp may be included to indicate when the new tracking area field will change is included. This may also be considered a validity time to ensure that the UE will keep updated on the system information when connected to a mobile IAB cell.

In certain examples, the UE may be paged, for example via Short Message paging (the same as used for emergency notifications and system modification procedures) when the new tracking area field has changed. This paging may only be considered by the mobile IAB enhanced UEs. This may for instance be achieved by introducing a new field in Short Message (which is only interpreted by mobile IAB enhanced UEs) mIAB-trackingAreaUpdate.

In certain examples, the UE may be considered an enhanced mobile IAB UE if it supports TA enhancements above (i.e. that the UE is capable of choosing multiple TAs).

gNB-CU TAC Signalling

As described above, TACs may be broadcast by a mobile IAB, which may then be applied by a UE. In certain examples, TACs for an IAB-MT part of the mobile IAB may be handled. Accordingly, in certain examples, the techniques disclosed herein may be extended to a gNB(-CU) signalling multiple tracking areas, which are applied by a mobile IAB-MT. For instance the IAB-MT may only apply the new tracking area field.

Various examples have been disclosed herein relating to a mobile IAB node. However, the skilled person will appreciate that the present disclosure is not limited to this example. For example, the techniques disclosed herein may be applied to any other suitable type of mobile relay node. More broadly, the techniques described herein may be applied to any suitable type of mobile access node. Even more broadly, the techniques disclosed herein may be applied to non-mobile (e.g. stationary or fixed) nodes. For example, the techniques may be applied in the case of a fixed access node in a Non-Terrestrial Network (NTN) in which the cells of the NTN move, for example due to movement of the satellites providing the cell coverage. In this case, a fixed node corresponds to an mIAB node in the above examples, and a moving NTN cell corresponds to a fixed cell in the above examples. The skilled person will appreciate that the techniques disclosed herein may be applied when an access node needs to change TAC.

The skilled person will appreciate that the identification of a tracking area is not limited to a TAC, and that any suitable type and/or format of identification may be used. The skilled person will also appreciate that when two or more TACs are included in system information, at least some of the TACs may be the same (i.e. have the same value). For example, a first TAC in a first field may have the same value as a second TAC in a second field, or two TACs in the same field may have the same value.

### SPECIFICATION EXAMPLES

### Example 1

### 3GPP TS 38.331 V17.3.0

### 5.2.2.4.2 Actions Upon Reception of the SIB1

Upon receiving the SIB1 the UE shall:
1> store the acquired SIB1;
1> if the UE is a RedCap UE and it is in RRC_IDLE or in RRC_INACTIVE, or if the RedCap UE is in RRC_CONNECTED while T311 is running:
   2> if intraFreqReselectionRedCap is not present in SIB1:
      3> consider the cell as barred in accordance with TS 38.304 [20];
      3> perform barring as if intraFreqReselectionRedCap is set to allowed;
   2> else:
      3> if the cellBarredRedCap1Rx is present in the acquired SIB1 and is set to barred and the UE is equipped with 1 Rx branch; or
      3> if the cellBarredRedCap2Rx is present in the acquired SIB1 and is set to barred and the UE is equipped with 2 Rx branches; or
      3> if the halfDuplexRedCapAllowed is not present in the acquired SIB1 and the UE supports only half-duplex FDD operation:
         4> consider the cell as barred in accordance with TS 38.304 [20];
         4> perform barring based on intraFreqReselectionRedCap as specified in TS 38.304 [20];
1> if the cellAccessRelatedInfo contains an entry of a selected SNPN or PLMN and in case of PLMN the UE is either allowed or instructed to access the PLMN via a cell for which at least one CAG ID is broadcast:
   2> in the remainder of the procedures use npn-IdentityList, trackingAreaCode, and cellIdentity for the cell as received in the corresponding entry of npnIdentityInfoList containing the selected PLMN or SNPN;
1> else if the cellAccessRelatedInfo contains an entry with the PLMN-Identity of the selected PLMN:
   2> in the remainder of the procedures use plmn-IdentityList, trackingAreaCode, trackingAreaList, and cellIdentity for the cell as received in the corresponding PLMNIdentityInfo containing the selected PLMN;
1> if in RRC_CONNECTED while T311 is not running:
   2> disregard the frequencyBandList, if received, while in RRC_CONNECTED;
   2> forward the cellIdentity to upper layers;
   2> if the UE is a mobile IAB enhanced UE, the cell is a mobile IAB and trackingAreaList is included
      3> forward trackingAreaCode and trackingAreaList to upper layers, if included;
   2> else:
      3> forward the trackingAreaCode to upper layers, if included;
      3> forward the trackingAreaList to upper layers, if included;
   2> forward the received posSIB-MappingInfo to upper layers, if included;
   2> apply the configuration included in the servingCellConfigCommon;
   2> if the UE has a stored valid version of a SIB or posSIB, in accordance with clause 5.2.2.2.1, that the UE requires to operate within the cell in accordance with clause 5.2.2.1:
      3> use the stored version of the required SIB or posSIB;
   2> else:
      3> acquire the required SIB or posSIB requested by upper layer as defined in clause 5.2.2.3.5;

NOTE: Void.

### 3GPP TS 38.331 V17.3.0

### 3GPP TS 38.331 V17.3.0

### PLMN-Identity InfoList

The IE PLMN-IdentityInfoList includes a list of PLMN identity information.

### PLMN-IdentityInfoList Information Element

-- ASN1START
-- TAG-PLMN-IDENTITYINFOLIST-START
PLMN-IdentityInfoList ::= SEQUENCE (SIZE (1..maxPLMN)) OF PLMN-IdentityInfo
PLMN-IdentityInfo ::= SEQUENCE {
plmn-Identity List SEQUENCE (SIZE (1..maxPLMN)) OF PLMN-Identity,
trackingAreaCode TrackingAreaCode OPTIONAL, -- Need R
ranac RAN-AreaCode OPTIONAL, -- Need R
cellIdentity CellIdentity,
cellReservedForOperatorUse ENUMERATED {reserved, notReserved},
...,
└└
iab-Support-r16 ENUMERATED {true} OPTIONAL -- Need S
┘┘,
└└
trackingAreaList-r17 SEQUENCE (SIZE (1..maxTAC-r17)) OF TrackingAreaCode OPTIONAL, -- Need R
gNB-ID-Length-r17 INTEGER (22..32) OPTIONAL -- Need R
┘┘
}
-- TAG-PLMN-IDENTITYINFOLIST-STOP
-- ASN1STOP

TABLE 2
PLMN-IdentityInfo field descriptions

cellReservedForOperatorUse
Indicates whether the cell is reserved for operator use (per PLMN), as
defined in TS 38.304 [20]. This field is ignored by IAB-MT.
gNB-ID-Length
Indicates the length of the gNB ID out of the 36-bit long cellIdentity.
iab-Support
This field combines both the support of IAB and the cell status for
IAB. If the field is present, the cell supports IAB and the cell is also
considered as a candidate for cell (re)selection for IAB-node;
if the field is absent, the cell does not support IAB and/or the
cell is barred for IAB-node.
trackingAreaCode
Indicates Tracking Area Code to which the cell indicated by
cellIdentity field belongs. The absence of the field indicates that
the cell only supports PSCell/SCell functionality (per PLMN) or
is an NTN cell.
For a mobile IAB enhanced/capable UE, this field together
with trackingAreaList is considered to be the tracking areas
of the cell.
trackingAreaList
List of Tracking Areas to which the cell indicated by cellIdentity
field belongs. If this field is present, network does not configure
trackingAreaCode. Total number of different TACs across
different PLMN-IdentityInfos shall not exceed maxTAC. For a
mobile IAB capable UE, this field together with trackingAreaCode
is considered the tracking areas of the cell.

### 3GPP TS 38.331 V17.3.0

### Example 2

### 3GPP TS 38.331 V17.3.0

### 5.2.2.4.2 Actions Upon Reception of the SIB1

Upon receiving the SIB1 the UE shall:
1> store the acquired SIB1;
1> if the UE is a RedCap UE and it is in RRC_IDLE or in RRC_INACTIVE, or if the RedCap UE is in RRC_CONNECTED while T311 is running:
   2> if intraFreqReselectionRedCap is not present in SIB1:
      3> consider the cell as barred in accordance with TS 38.304 [20];
      3> perform barring as if intraFreqReselectionRedCap is set to allowed;
   2> else:
      3> if the cellBarredRedCap1Rx is present in the acquired SIB1 and is set to barred and the UE is equipped with 1 Rx branch; or
      3> if the cellBarredRedCap2Rx is present in the acquired SIB1 and is set to barred and the UE is equipped with 2 Rx branches; or
      3> if the halfDuplexRedCapAllowed is not present in the acquired SIB1 and the UE supports only half-duplex FDD operation:
         4> consider the cell as barred in accordance with TS 38.304 [20];
         4> perform barring based on intraFreqReselectionRedCap as specified in TS 38.304 [20];
1> if the cellAccessRelatedInfo contains an entry of a selected SNPN or PLMN and in case of PLMN the UE is either allowed or instructed to access the PLMN via a cell for which at least one CAG ID is broadcast:
   2> in the remainder of the procedures use npn-IdentityList, trackingAreaCode, and cellIdentity for the cell as received in the corresponding entry of npnIdentityInfoList containing the selected PLMN or SNPN;
1> else if the cellAccessRelatedInfo contains an entry with the PLMN-Identity of the selected PLMN:
   2> in the remainder of the procedures use plmn-IdentityList, trackingAreaCode, trackingAreaList, and cellIdentity for the cell as received in the corresponding PLMNIdentityInfo containing the selected PLMN;
1> if in RRC_CONNECTED while T311 is not running:
   2> disregard the frequencyBandList, if received, while in RRC_CONNECTED;
   2> forward the cellIdentity to upper layers;
   2> if the UE is a mobile IAB enhanced UE, the cell is a mobile IAB and trackingAreaList is included
      3> forward either trackingAreaCode or trackingAreaList to upper layers, if included;
   2> else:
      3> forward the trackingAreaCode to upper layers, if included;
      3> forward the trackingAreaList to upper layers, if included;
   2> forward the received posSIB-MappingInfo to upper layers, if included;
   2> apply the configuration included in the servingCellConfigCommon;
   2> if the UE has a stored valid version of a SIB or posSIB, in accordance with clause 5.2.2.2.1, that the UE requires to operate within the cell in accordance with clause 5.2.2.1:
      3> use the stored version of the required SIB or posSIB;
   2> else:
      3> acquire the required SIB or posSIB requested by upper layer as defined in clause 5.2.2.3.5;

NOTE: Void.

### 3GPP TS 38.331 V17.3.0

### 3GPP TS 38.331 V17.3.0

### PLMN-IdentityInfoList

The IE PLMN-IdentityInfoList includes a list of PLMN identity information.

### PLMN-IdentityInfoList Information Element

-- ASN1START
-- TAG-PLMN-IDENTITYINFOLIST-START
PLMN-IdentityInfoList ::= SEQUENCE (SIZE (1..maxPLMN)) OF PLMN-IdentityInfo
PLMN-IdentityInfo ::= SEQUENCE {
plmn-Identity List SEQUENCE (SIZE (1..maxPLMN)) OF PLMN-Identity,
trackingAreaCode TrackingAreaCode OPTIONAL, -- Need R
ranac RAN-AreaCode OPTIONAL, -- Need R
cellIdentity CellIdentity,
cellReservedForOperatorUse ENUMERATED {reserved, notReserved},
...,
└└
iab-Support-r16 ENUMERATED {true} OPTIONAL -- Need S
┘┘,
└└
trackingAreaList-r17 SEQUENCE (SIZE (1..maxTAC-r17)) OF TrackingAreaCode OPTIONAL, -- Need R
gNB-ID-Length-r17 INTEGER (22..32) OPTIONAL -- Need R
┘┘
}
-- TAG-PLMN-IDENTITYINFOLIST-STOP
-- ASN1STOP

TABLE 3
PLMN-IdentityInfo field descriptions

cellReservedForOperatorUse
Indicates whether the cell is reserved for operator use (per PLMN),
as defined in TS 38.304 [20]. This field is ignored by IAB-MT.
gNB-ID-Length
Indicates the length of the gNB ID out of the 36-bit long cellIdentity.
iab-Support
This field combines both the support of IAB and the cell status for
IAB. If the field is present, the cell supports IAB and the cell is also
considered as a candidate for cell (re)selection for IAB-node; if the
field is absent, the cell does not support IAB and/or the cell is
barred for IAB-node.
trackingAreaCode
Indicates Tracking Area Code to which the cell indicated by
cellIdentity field belongs. The absence of the field indicates
that the cell only supports PSCell/SCell functionality (per
PLMN) or is an NTN cell.
For a mobile IAB enhanced/capable UE, this field or trackingAreaList
is considered the tracking areas of the cell.
trackingAreaList
List of Tracking Areas to which the cell indicated by cellIdentity
field belongs. If this field is present, network does not configure
trackingAreaCode. Total number of different TACs across different
PLMN-IdentityInfos shall not exceed maxTAC. For a mobile IAB
capable UE, this field or trackingAreaCode is considered the
tracking areas of the cell.

### 3GPP TS 38.331 V17.3.0

### Example 3

### 3GPP TS 38.331 V17.3.0

### PLMN-IdentityInfoList

The IE PLMN-IdentityInfoList includes a list of PLMN identity information.

### PLMN-IdentityInfoList Information Element

-- ASN1START
-- TAG-PLMN-IDENTITYINFOLIST-START
PLMN-IdentityInfoList ::= SEQUENCE (SIZE (1..maxPLMN)) OF PLMN-IdentityInfo
PLMN-IdentityInfo ::= SEQUENCE {
plmn-IdentityList SEQUENCE (SIZE (1..maxPLMN)) OF PLMN-Identity,
trackingAreaCode TrackingAreaCode OPTIONAL, -- Need R
ranac RAN-AreaCode OPTIONAL, -- Need R
cellIdentity CellIdentity,
cellReservedForOperatorUse ENUMERATED {reserved, notReserved},
...,
└└
iab-Support-r16 ENUMERATED {true} OPTIONAL -- Need S
┘┘,
└└
trackingAreaList-r17 SEQUENCE (SIZE (1..maxTAC-r17)) OF TrackingAreaCode OPTIONAL, -- Need R
gNB-ID-Length-r17 INTEGER (22..32) OPTIONAL -- Need R
┘┘
}
-- TAG-PLMN-IDENTITYINFOLIST-STOP
-- ASN1STOP

TABLE 4
PLMN-IdentityInfo field descriptions

cellReservedForOperatorUse
Indicates whether the cell is reserved for operator use (per PLMN),
as defined in TS 38.304 [20]. This field is ignored by IAB-MT.
gNB-ID-Length
Indicates the length of the gNB ID out of the 36-bit long cellIdentity.
iab-Support
This field combines both the support of IAB and the cell status for
IAB. If the field is present, the cell supports IAB and the cell is also
considered as a candidate for cell (re)selection for IAB-node; if the
field is absent, the cell does not support IAB and/or the cell is
barred for IAB-node.
trackingAreaCode
Indicates Tracking Area Code to which the cell indicated by
cellIdentity field belongs. The absence of the field indicates that
the cell only supports PSCell/SCell functionality (per PLMN)
or is an NTN cell.
For a mobile IAB enhanced/capable UE, if trackingAreaList is
provided this field is ignored.
trackingAreaList
List of Tracking Areas to which the cell indicated by cellIdentity
field belongs. If this field is present, network does not configure
trackingAreaCode. Total number of different TACs across different
PLMN-IdentityInfos shall not exceed maxTAC. For a mobile IAB
enhanced/capable UE, this field is used as the trackingAreaCode
of the cell.

### 3GPP TS 38.331 V17.3.0

### Example 4

### 3GPP TS 38.331 V17.3.0

### 5.2.2.4.2 Actions Upon Reception of the SIB1

Upon receiving the SIB1 the UE shall:
1> store the acquired SIB1;
1> if the UE is a RedCap UE and it is in RRC_IDLE or in RRC_INACTIVE, or if the RedCap UE is in RRC_CONNECTED while T311 is running:
   2> if intraFreqReselectionRedCap is not present in SIB1:
      3> consider the cell as barred in accordance with TS 38.304 [20];
      3> perform barring as if intraFreqReselectionRedCap is set to allowed;
   2> else:
      3> if the cellBarredRedCap1Rx is present in the acquired SIB1 and is set to barred and the UE is equipped with 1 Rx branch; or
      3> if the cellBarredRedCap2Rx is present in the acquired SIB1 and is set to barred and the UE is equipped with 2 Rx branches; or
      3> if the halfDuplexRedCapAllowed is not present in the acquired SIB1 and the UE supports only half-duplex FDD operation:
         4> consider the cell as barred in accordance with TS 38.304 [20];
         4> perform barring based on intraFreqReselectionRedCap as specified in TS 38.304 [20];
1> if the cellAccessRelatedInfo contains an entry of a selected SNPN or PLMN and in case of PLMN the UE is either allowed or instructed to access the PLMN via a cell for which at least one CAG ID is broadcast:
   2> in the remainder of the procedures use npn-IdentityList, trackingAreaCode, and cellIdentity for the cell as received in the corresponding entry of npnIdentityInfoList containing the selected PLMN or SNPN;
1> else if the cellAccessRelatedInfo contains an entry with the PLMN-Identity of the selected PLMN:
   2> in the remainder of the procedures use plmn-IdentityList, trackingAreaCode, trackingAreaList, and cellIdentity for the cell as received in the corresponding PLMNIdentityInfo containing the selected PLMN;
1> if in RRC_CONNECTED while T311 is not running:
   2> disregard the frequencyBandList, if received, while in RRC_CONNECTED;
   2> forward the cellIdentity to upper layers;
   2> if the UE is a mobile IAB enhanced UE and UE is in a High-mobility state according to 38.304, the cell is a mobile IAB and trackingAreaList is included
      3> forward either trackingAreaCode or trackingAreaList to upper layers, if included;
   2> else:
      3> forward the trackingAreaCode to upper layers, if included;
      3> forward the trackingAreaList to upper layers, if included;
   2> forward the received posSIB-MappingInfo to upper layers, if included;
   2> apply the configuration included in the servingCellConfigCommon;
   2> if the UE has a stored valid version of a SIB or posSIB, in accordance with clause 5.2.2.2.1, that the UE requires to operate within the cell in accordance with clause 5.2.2.1:
      3> use the stored version of the required SIB or posSIB;
   2> else:
      3> acquire the required SIB or posSIB requested by upper layer as defined in clause 5.2.2.3.5;

NOTE: Void.

### 3GPP TS 38.331 V17.3.0

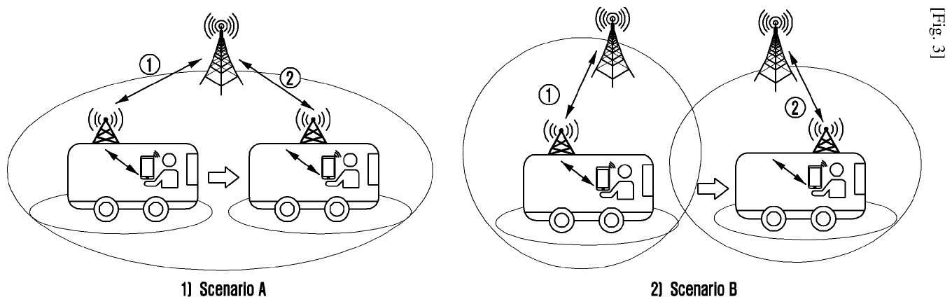

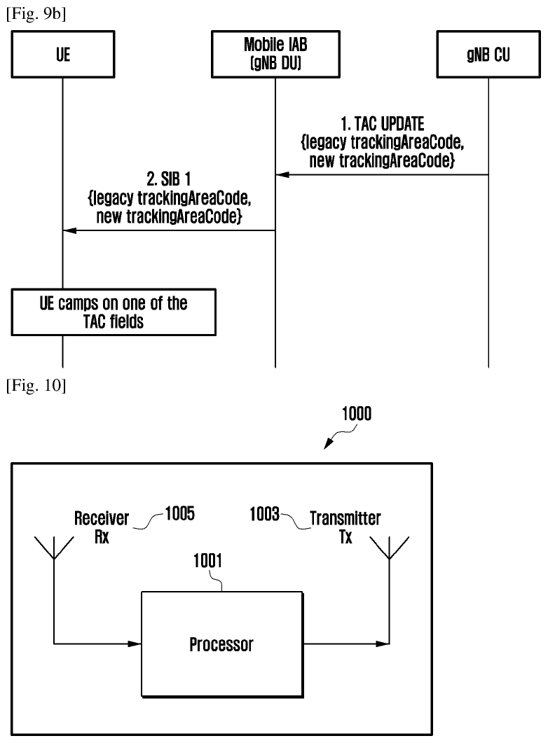

FIG. 10 is a block diagram of an exemplary network entity that may be used in examples of the present disclosure. For example, the UE, gNB, IAB and/or other NFs in the examples of FIGS. 1-9 may be provided in the form of the network entity illustrated in FIG. 10. The skilled person will appreciate that a network entity may be implemented, for example, as a network element on a dedicated hardware, as a software instance running on a dedicated hardware, and/or as a virtualised function instantiated on an appropriate platform (e.g. on a cloud infrastructure).

The entity 1000 comprises a processor (or controller) 1001, a transmitter 1003 and a receiver 1005. The receiver 1005 is configured for receiving one or more messages from one or more other network entities, for example as described above. The transmitter 1003 is configured for transmitting one or more messages to one or more other network entities, for example as described above. The processor 1001 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

### Abbreviations/Definitions

In the present disclosure, the following acronyms/definitions are used.
3GPP 3^{rd} Generation Partnership Project
5G 5^{th} Generation
AMF Access and Mobility management Function
AS Access Stratum
BWP Bandwidth Part
CAG Closed Access Group
CM Connected Mode
CU Central Unit
dBm decibel-milliwatts
DU Distributed Unit
eNB Base Station
EN-DC E-UTRA NR Dual Connectivity
E-UTRAN Evolved Universal Terrestrial Radio Access Network
F1 Interface between gNB-CU and gNB-DU
F1AP F1 Application Protocol
FDD Frequency Division Duplex
gNB 5G NR Base Station
IAB Integrated Access and Backhaul
ID Identity/Identification
IE Information Element
IMS IP Multimedia Subsystem
LTE Long Term Evolution
MBSR Mobile Base Station Relay
mIAB Mobile IAB
MT Mobile Termination
NAS Non Access Stratum
NB Base Station
NF Network Function
NG Next Generation
NR New Radio
NTN Non-Terrestrial Network
PDU Protocol Data Unit
PLMN Public Land Mobile Network
PSCell Primary and Secondary Cell
QoS Quality of Service
RAN Radio Access Network
RANAC RAN Area Code
RAT Radio Access Technology
Rel Release
RNA RAN Notification Area
RRC Radio Resource Control
RSRP Reference Signal Received Power
Rx Receive
SCell Secondary Cell
SCS Sub-Carrier Spacing
SIB System Information Block
SNPN Standalone Non-Public Network
TA Tracking Area
TAC Tracking Area Code
TAG Timing Advance Group
TAU Tracking Area Update
TR Technical Report
TS Technical Specification
Txxx Timer xxx
UE User Equipment
WG Working Group
WID Work Item Description

1. A method of a mobile integrated access and backhaul (IAB) node in a wireless communication network, the method comprising:
obtaining system information including a first field in which a first tracking area code (TAC) is set and a second field in which a second TAC is set; and
broadcasting the system information,
wherein the first TAC is for a first group of user equipments (UEs) connected to the mobile IAB node, and the second TAC is for a second group of UEs connected to the mobile IAB node.

2. The method of claim 1,
wherein the first group of UEs are a first type of UEs legacy UEs,
wherein the second group of UEs are a second type of UEs, and
wherein the first type of UEs are legacy UEs and second type of UEs are enhanced UEs.

3. The method of claim 1, wherein in case that the mobile IAB node is located in a first area corresponding to a first fixed cell associated with a third TAC, the first field is set to the third TAC and the second field is set to the third TAC.

4. The method of claim 3, wherein in case that the mobile IAB node moves from the first area corresponding to the first cell associated with the third TAC to a second area corresponding to the first cell associated with the third TAC and a second cell associated with a fourth TAC, a TAC set in the second field is changed from the third TAC to the fourth TAC.

5. The method of claim 4, wherein in case that the mobile IAB node moves from the second area corresponding to the first cell associated with the third TAC and a second cell associated with a fourth TAC to a third area corresponding to the second cell associated with the fourth TAC, a TAC set in the first field is changed from the third TAC to the fourth TAC.

6. The method of claim 3,
wherein a TAC set in the first field and a TAC set in the second field is changed at different times.

7. The method of claim 1,
wherein the system information is included in a system information block 1 (SIB 1).

8. A mobile integrated access and backhaul (IAB) node in a wireless communication network, the mobile IAB node comprising:
a transceiver; and
a processor configured to:
obtain system information including a first field in which a first tracking area code (TAC) is set and a second field in which a second TAC is set, and
broadcast the system information,
wherein the first TAC is for a first group of user equipments (UEs) connected to the mobile IAB node, and the second TAC is for a second group of UEs connected to the mobile IAB node.

9. The mobile IAB node of claim 8,
wherein the first group of UEs are a first type of UEs legacy UEs,
wherein the second group of UEs are a second type of UEs, and
wherein the first type of UEs are legacy UEs and second type of UEs are enhanced UEs.

10. The mobile IAB node of claim 8, wherein in case that the mobile IAB node is located in a first area corresponding to a first fixed cell associated with a third TAC, the first field is set to the third TAC and the second field is set to the third TAC.

11. The mobile IAB node of claim 10, wherein in case that the mobile IAB node moves from the first area corresponding to the first cell associated with the third TAC to a second area corresponding to the first cell associated with the third TAC and a second cell associated with a fourth TAC, a TAC set in the second field is changed from the third TAC to the fourth TAC.

12. The mobile IAB node of claim 11, wherein in case that the mobile IAB node moves from the second area corresponding to the first cell associated with the third TAC and a second cell associated with a fourth TAC to a third area corresponding to the second cell associated with the fourth TAC, a TAC set in the first field is changed from the third TAC to the fourth TAC.

13. The mobile IAB node of claim 10,
wherein a TAC set in the first field and a TAC set in the second field is changed at different times.

14. The mobile IAB node of claim 8,
wherein the system information is included in a system information block 1 (SIB 1).
